(19) United States
(12) Patent Application Publication
(10) Pub. No.: US 2008/0227885 A1
(43) Pub. Date: Sep. 18, 2008

(54) Active Energy Beam-Curable Composition for Optical Material

(76) Inventor: Yasuyuki Sanai, Aichi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/589,660

(22) PCT Filed: Feb. 16, 2005
(86) PCT No.: PCT/JP2005/002311

§ 371 Date: Aug. 16, 2006

(30) Foreign Application Priority Data
Feb. 17, 2004 (JP) 2004-040310

(51) Int. Cl. C08F 2/46

(52) U.S. Cl. 522/180; 522/182

(57) ABSTRACT

The active energy beam-curable composition for an optical material is provided that comprises (A) a di(meth)acrylate represented by the following general formula (1) and (B) a mono(meth)acrylate represented by the following general formula (2). A method for producing an optical material includes a step of applying or pouring the composition to a casting mold having a predetermined shape, and a step of irradiating an active energy beam to the composition.

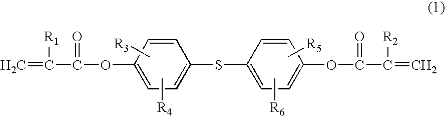

In formula (1), R₁ and R₂ independently represent a hydrogen atom or a methyl group, R₃ and R₅ independently represent a hydrogen atom, a methyl group or an ethyl group, R₄ to R₆ independently represent a hydrogen atom, a methyl group or a bromine atom.

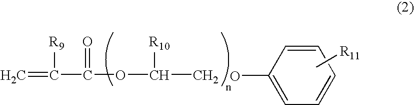

In formula (2), R₉ and R₁₀ independently represent a hydrogen atom or a methyl group, R₁₁ represents a hydrogen atom, a phenyl group or a cumyl group, and n represents 0 or an integer of 1-5.

### BACKGROUND OF THE INVENTION

1. Field of the Invention

The present invention relates to an active energy beam-curable composition for an optical material, and belongs to the technical field of an active energy beam-curable composition and an optical material such as a lens sheet, a plastic lens and the like.

2. Description of the Related Art

Conventionally, a lens sheet such as a Fresnel lens, a lenticular lens and the like is manufactured by molding using a method such as a press method, a cast method and the like.

However, the former press method has such problem that the productivity is low because the production is carried out by a cycle of heating, pressurizing and cooling. On the other hand, the latter cast method has such a problem as an increased production cost due to a lot of necessary molds in addition to a long production time because of a process in which a monomer is cast in a mold to polymerize.

In order to solve such problems, there are various proposals for the use of an active energy beam-curable composition (for example, JP-A-61-177215 (Claim), JP-A-61-248707 (Claim), JP-A-61-248708 (Claim), JP-A-63-163330 (Claim), JP-A-63-167301 (Claim) and JP-A-63-199302 (Claim)), JP-A denotes a Japanese unexamined patent application publication).

However, conventional active energy beam-curable compositions are insufficient in refractive index and transparency. In order to further improve the point, a composition is examined in which a bisphenol di(meth)acrylate and a mono(meth)acrylate having an aromatic ring are used in a combination (for example, JP-A-9-87336 (Claim) and Japanese Patent No. 3397448 (Claim)).

### BRIEF SUMMARY OF THE INVENTION

However, the above-mentioned active energy beam-curable composition is insufficient for applications wherein a higher refractive index and transparency are required as is the case for thickness reduction of a projection television and the like.

The present inventor made an intensive investigation in order to find an active energy beam-curable composition for an optical material to give a cured article having an excellent transparency and being capable of satisfying both of a high refractive index and a high light transmittance.

The present inventor carried out various studies in order to solve the above-mentioned problem to find that a composition containing specific 2 types of (meth)acrylates cures rapidly with an active energy beam, and that the cured article is excellent in transparency, refractive index and light transmittance, thereby completing the present invention.

The present invention will be described in detail below.

In this connection, in the present description, “acrylate or methacrylate” will be represented as “(meth)acrylate”, and “acryloyl or methacryloyl” as “(meth)acryloyl”.

### DETAILED DESCRIPTION OF THE INVENTION

The present invention relates to an active energy beam-curable composition for an optical material including (A) a di(meth)acrylate represented by general formula (1) below (hereinafter, simply referred to as the components (A)) and (B) a mono(meth)acrylate represented by general formula (2) below (hereinafter, simply referred to as the component (B)).

Description will be given below about respective components.

### 1. Component (A)

The component (A) is a di(meth)acrylate represented by the following general formula (1), which is a component that gives a high refractive index to a cured article of the composition and improves strength of the cured article through cross-linking.

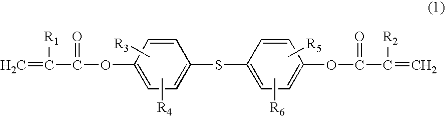

wherein R₁ and R₂ independently represent a hydrogen atom or a methyl group, R₃ and R₅ independently represent a hydrogen atom, a methyl group or an ethyl group, R₄ to R₆ independently represent a hydrogen atom, a methyl group or a bromine atom.

As to R₁ and R₂, each of them is preferably a hydrogen atom because a composition having an excellent curability is resulted in. As to R₃ to R₆, such compounds are preferable that all of R₃ to R₆ are hydrogen atoms, R₃ and R₅ are hydrogen atoms and R₄ and R₆ are methyl groups, and that R₃ and R₅ are hydrogen atoms and R₄ and R₆ are bromine atoms, because a high refractive index can be obtained and, further, such compound can be synthesized with a high yield. A compound having a lot of bulky substituents may require a long reaction time when the component (A) is synthesized, or decrease a yield after the reaction.

Specific examples of the component (A) include bis(4-(meth)acryloyloxyphenyl) sulfide, bis(4-(meth)acryloyloxy-3-methylphenyl) sulfide, bis(4-(meth)acryloyloxy-3-bromophenyl) sulfide and the like.

Among these, since excellent curability is resulted in, bis(4-acryloxyphenyl) sulfide and bis(4-acryloxy-3-methylphenyl) sulfide are more preferable.

These components (A) may be used singly or in a combination of 2 or more types.

### 2. Component (B)

The component (B) is a (meth)acrylate represented by the following general formula (2), which is a component that gives a high refractive index to a cured article of the composition, and that prevents crystallization of the composition.

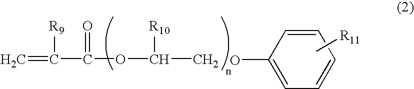

wherein R₉ and R₁₀ independently represent a hydrogen atom or a methyl group, R₁₁ represents a hydrogen atom, a phenyl group or a cumyl group, and n represents 0 or an integer of 1-5.

Specific examples of the component (B) include phenyl (meth)acrylate, p-cumylphenyl (meth)acrylate, o-phenylphenyl (meth)acrylate, m-phenylphenyl (meth)acrylate, p-phenylphenyl (meth)acrylate, phenoxyethyl (meth)acrylate, p-cumylphenoxyethyl (meth)acrylate, o-phenylphenoxyethyl (meth)acrylate, m-phenylphenoxyethyl (meth)acrylate, p-phenylphenoxyethyl (meth)acrylate and the like.

As the component (B), R₉ is preferably a hydrogen atom because a good curability is obtained. Further, n is preferably 0-2, and more preferably 0 because a resulting cured article has a higher refractive index.

Among these, o-phenylphenyl (meth)acrylate, p-cumylphenyl (meth)acrylate, p-cumylphenoxyethyl (meth)acrylate and o-phenylphenoxyethyl (meth)acrylate are preferable because they are liquid at room temperature and easy to handle, give a high refractive index, and easily available.

The component (B) may be used singly or in a combination of 2 or more types.

### 3. Other Components

The composition of the present invention requires the above-mentioned component (A) and (B) as indispensable components, and other components may be blended according to need.

In order to make the composition of the present invention be a visible ray- or ultraviolet ray-curable composition, the composition is blended with a photopolymerization initiator. Here, in order to make the composition be an electron beam-curable composition, a photopolymerization initiator is not necessarily blended.

Specific examples of the photoinitiator (hereinafter, referred to as the component (C)) include benzoins such as benzoin, benzoin methyl ether and benzoin propyl ether; acetophenones such as acetophenone, 2,2-dimethoxy-2-phenylacetophenone, 2,2-diethoxy-2-phenylacetophenone, 1,1-dichloroacetophenone, 1-hydroxycyclohexylphenylketone, 2-methyl-1-[4-(methylthio)phenyl]-2-morpholino-porpane-1-one and N,N-dimethylaminoacetophenone; anthraquinones such as 2-methylanthraquinone, 1-chloroanthraquinone and 2-amylanthraquinone; thioxanthones such as 2,4-dimethylthioxanthone, 2,4-diethylthioxanthone, 2-chlorothioxanthone and 2,4-diisopropylthioxanthone; ketals such as acetophenone dimethylketal and benzyl dimethylketal; benzophenones such as benzophenone, methylbenzophenone, 4,4′-dichlorobenzophenone, 4,4′-bisdiethylamino benzophenone, Michler's ketone and 4-benzoyl-4′-methyldiphenyl sulfide; 2,4,6-trimethylbenzoyidiphenylphosphine oxide and the like.

These components (C) may be used singly or in a combination of 2 or more types.

The component (C) may be used in a combination with a photosensitizer according to need. Examples of the photosensitizer include N,N-dimethylaminobenzoic acid ethyl ester, N,N-dimethylaminobenzoic acid isoamyl ester, triethylamine, triethanolamine and the like.

The blending percentage of the component (C) is preferably 0.05 to 12 parts by weight, more preferably 0.1 to 5 parts by weight, relative to the total 100 parts by weight of the components (A) and (B), or, when an unsaturated group-containing compound to be described below is blended, relative to the total 100 parts by weight of the components (A) and (B) and the unsaturated group-containing compound. The percentage of less than 0.05 part by weight may results in an insufficient curability and, on the other hand, that of more than 12 parts by weight may color the cured article, which is an unsuitable one for an optical material.

The composition of the present invention may be blended with an unsaturated group-containing compound other than the components (A) and (B) according to need.

Examples of the unsaturated group-containing compound include vinyl compounds such as N-vinyl caprolactone; mono(meth)acrylates such as carbitol (meth)acrylate, (meth)acryloyl morpholine, glycidyl (meth)acrylate, 2-hydroxyethyl (meth)acrylate, 2-hydroxypropyl (meth)acrylate, 1,4-butanediol mono(meth)acrylate, 2-hydroxy-3-phenyloxypropyl (meth)acrylate and tribromophenyloxyethyl (meth)acrylate; di(meth)acrylates of diol such as 1,6-hexanediol di(meth)acrylate, nonanediol di(meth)acrylate and polyethylene glycol di(meth)acrylate; 2,2-bis(4-(meth)acryloyloxyalkoxyphenyl)-propanes such as 2,2-bis(4-(meth)acryloyloxyethoxyphenyl)-propane, 2,2-bis(4-(meth)acryloyloxydiethoxyphenyl)-propane and 2,2-bis(4-(meth)acryloyloxytriethoxyphenyl)-propane; bis(4-(meth)acryloyloxyalkoxyphenyl) sulfides such as bis(4-(meth)acryloyloxyethoxyphenyl) sulfide, bis(4-(meth)acryloyloxydiethoxyphenyl) sulfide, bis(4-(meth)acryloyloxytriethoxyphenyl) sulfide, bis(4-(meth)acryloyloxydiethoxy-3-methylphenyl) sulfide, bis(4-(meth)acryloyloxyethoxy-3-bromophenyl) sulfide, and bis(4-(meth)acryloyloxydiethoxy-3-bromophenyl) sulfide; (meth)acrylates having 3 or more (meth)acryloyl groups such as trimethylolpropane tri(meth)acrylate and pentaerythritol tetra(meth)acrylate; (meth)acrylate oligomers such as bisphenol A epoxy resin di(meth)acrylate, various types of polyurethane poly(meth)acrylate and polyester poly(meth)acrylate; and the like.

The unsaturated group-containing compound is preferably blended in the composition in a range of 0 to 50 wt %.

In addition to the above-mentioned components, according to need, pigment, dye, an antifoaming agent, a leveling agent, an inorganic filler, an organic filler, a light stabilizer, an oxidation inhibitor, an ultraviolet absorber or the like may be blended. Further, according to need, a small amount of an oxidation inhibitor, a light stabilizer, an ultraviolet absorber or a polymerization inhibitor may also be added.

For the purpose of further proceeding of cure, the composition of the present invention may be blended with a thermal polymerization initiator and heated after irradiation of an active energy beam.

As the thermal polymerization initiator, various compounds may be used, and an organic peroxide or an azo-based initiator is preferable.

Specific examples of the organic peroxide include 1,1-bis(t-butylperoxy)-2-methylcyclohexane, 1,1-bis(t-hexylperoxy)-3,3,5-trimethylcyclohexane, 1,1-bis(t-hexylperoxy)cyclohexane, 1,1-bis(t-butylperoxy)-3,3,5-trimethylcyclohexane, 1,1-bis(t-butylperoxy)cyclohexane, 2,2-bis(4,4-di-butylperoxycyclohexyl)propane, 1,1-bis(t-butylperoxy)cycidodecane, t-hexylperoxyisopropyl monocarbonate, t-butylperoxy maleic acid, t-butylperoxy-3,5,5-trimethyl hexanoate, t-butylperoxy laurate, 2,5-dimethyl-2,5-di(m-toluoylperoxy)hexane, t-butylperoxyisopropyl monocarbonate, t-butylperoxy-2-ethylhexyl monocarbonate, t-hexylperoxybenzoate, 2,5-dimethyl-2,5-di(benzoylperoxy)hexane, t-butylperoxyacetate, 2,2-bis(t-butylperoxy)butane, t-butyl peroxybenzoate, n-butyl-4,4-bis(t-butylperoxy) valerate, di-t-butylperoxy isophthalate, □,□′-bis(t-butylperoxy)diisopropylbenzene, dicumyl peroxide, 2,5-dimethyl-2,5-di(t-butylperoxy)hexane, t-butylcumyl peroxide, di-t-butyl peroxide, p-menthane hydroperoxide, 2,5-dimethyl-2,5-di(t-butylperoxy)hexyne-3, diisopropylbenzene hydroperoxide, t-butyltrimethylsilyl peroxide, 1,1,3,3-tetramethylbutyl hydroperoxide, cumene hydroperoxide, t-hexylhydro peroxide, t-butyl hydroperoxide and the like.

Specific examples of the azo-based compound include 1,1′-azobis(cyclohexane-1-carbonitrile), 2-(carbamoylazo)isobutylonitrile, 2-phenylazo-4-methoxy-2,4-dimethylvaleronitrile, azodi-t-octane, azodi-t-butane and the like.

These compounds may be used singly or in a combination of 2 or more types. Further, the organic peroxide may be combined with a reducing agent to lead to a redox reaction.

### 4. The Active Energy Beam-Curable Composition for an Optical Material

The composition of the present invention can be manufactured by stirring and mixing the above-mentioned components (A) and (B), and other components if necessary according to an ordinary method.

Usually, the component (A) is solid, therefore when the composition does not become a liquid state, it may be heated after the stirring and mixing, wherein 50 to 100° C. is preferable.

The blending ratio of the component (A) and the component (B) is, on the basis of the total weight of the components (A) and (B), preferably 10 to 90 parts by weight of the component (A) and 90 to 10 parts by weight of the component (B), and more preferably 30 to 80 parts by weight of the component (A) and 70 to 20 parts by weight of the component (B). The ratio of the component (A) less than 10 parts by weight may not give a designed refractive index and, on the other hand, the ratio of the component (A) more than 90 parts by weight may results in giving a cured article having an insufficient transparency with turbidity, because the component (A) crystallizes easily to allow curing and crystallization to proceed simultaneously during the process of the active energy beam-curing.

As to a method for using the composition of the present invention, according to an ordinary method, an active energy beam may by irradiated to the composition to cure the same.

The active energy beam includes an electron beam, visible rays, ultraviolet rays and the like. Among these, visible rays or ultraviolet rays are preferable because they do not require a particular apparatus and are easy to use. As an ultraviolet ray irradiation apparatus, there is a high-pressure mercury vapor lamp or the like.

The irradiation dose, irradiation time and the like of an active energy beam may be suitably set in accordance with the composition used and application.

The composition of the present invention can give a cured article having such high refractive index (25° C.) as normally 1.60 or more, and preferably 1.61 or more. In addition, the cured article is also excellent in transparency.

As described above, since the cured article of the composition of the present invention has a high refractive index and transparency, it can be used for various optical materials such as a lens sheet including a Fresnel lens, a lenticular lens, a prism sheet and the like, and a plastic lens.

In more detail, there are such applications for the lens sheet as a video projector, a projection television, a liquid crystal display and the like.

An example, in which the composition of the present invention is used for producing a lens sheet, will be described.

When a lens sheet having a relatively thin film thickness is to be produced, the composition of the present invention is applied to a casting mold, which is referred to as a stamper, having an intended lens shape to provide a layer of the composition, and then a transparent substrate is laminated on the layer.

Next, an active energy beam is irradiated through the transparent substrate to cure the composition, and then, the cured article is peeled off the casting mold.

On the other hand, when a lens sheet having a relatively thick film thickness is to be produced, the composition of the present invention is poured between a casting mold having an intended lens shape and a transparent substrate.

Then, an active energy beam is irradiated through the transparent substrate to cure the composition, and then, the cured article is demolded from the casting mold.

The transparent substrate is preferably a resin substrate, and specific examples thereof include a sheet-like methacrylic resin, polycarbonate resin, methylmethacrylate-styrene resin, styrene resin and the like.

The material of casting mold is not particularly restricted, and includes, for example, metals such as brass and nickel, and resins such as epoxy resin. From the viewpoint of a long lifetime of a casting mold, a mold of metal is preferable.

Next, an example, in which the composition of the present invention is used for producing a plastic lens, will be described.

For example, there is such method that the composition of the present invention is injected into a mirror finished casting mold having at least one transparent surface and exposed to an active energy beam to cure, which is then demolded.

Examples of the casting mold in this case include a mold of 2 mirror finished glasses, plastics or a combination thereof and a gasket made of a thermoplastic resin such as plasticized vinyl chloride and ethylene-vinyl acetate copolymer, one constituted by combining 2 molds and a mold clamper, and the like.

In this case, an active energy beam may be irradiated to one or both sides of the casting mold. Further, the irradiation of an active energy beam may be combined with heating.

The composition of the present invention is excellent in workability at room temperature, gives a cured article having an excellent transparency, a high refractive index and a good light transmittance, and can be suitably used for optical elements such as a lens sheet and a plastic lens for which transparency, a high refractive index and a high light transmittance are required.

The composition of the present invention contains the component (A) and the component (B) as indispensable components, wherein, as to the percentage thereof, 10 to 90 parts by weight of the component (A) and 90 to 10 parts by weight of the component (B) is preferable.

In the component (A), since the composition exerts an excellent curability and the cured article thereof has a high refractive index, preferably each of R₁ and R₂ is a hydrogen atom.

In the component (B), since the composition exerts an excellent curability and the cured article thereof has a high refractive index, preferably n is 0, and R₁₁ is a phenyl group or a cumyl group.

As the composition, one further containing the component (C) is preferable because an excellent curability is exerted.

In addition, the present invention provides a method for producing an optical material including the steps of applying or pouring the composition to a casting mold having a predetermined shape, and then irradiating an active energy beam to the composition.

### EXAMPLES

The present invention will be further specifically described below with reference to Examples and Comparative examples.

In this connection, in what follows, “part” means “part by weight”.

### EXAMPLES AND COMPARATIVE EXAMPLES

Respective components shown in Table 1 were stirred and mixed according to an ordinary method, which was heated in a dryer having been maintained previously at 80° C. over 15 minutes to dissolve a solid photoinitiator, thereby preparing an ultraviolet-curable composition.

The obtained composition was applied to a transparent OPP film (biaxially stretched polypropylene film TK, manufactured by NIPPON POLYACE Co., LTD.) having a thickness of 50 □m by a bar coater at room temperature to give a thickness of 30 □m, which was cured by irradiating ultraviolet rays twice with a high-pressure mercury vapor lamp of an output power of 160 W/cm under the condition of a conveyer speed of 10 m/min and a lamp height of 10 cm.

The obtained cured article was evaluated by means of the following method. The result is listed in Table 2.

### (1) Appearance

Presence or absence of turbidity of the obtained cured article was judged visually. One without turbidity is denoted by “Excellent”, and one with turbidity or color is denoted by “Poor”.

### (2) Refractive Index

The refractive index of the cured article (measured value at 25° C. using the sodium D line) was measured by an Abbe refractometer DR-M2 manufactured by ATAGO CO., LTD.

### (3) Light Transmittance

The light transmittance of the cured article (hereinafter, simply referred to as transmittance) was measured by V-550 manufactured by JASCO Corporation, wherein the transmittance at the wavelength of 400 nm was evaluated.

TABLE 1

| | | Composition (part) | | | | | | | | | |
|---|---|---|---|---|---|---|---|---|---|---|---|
| | | (A) | (B) | | | | | Other | | | (C) |
| | | BAPS | p-CPA | o-PPA | M-110 | TO-1463 | POA | M-400 | M-211B | BAEPS | Irg184 |
| Ex. | 1 | 70 | 30 | | | | | | | | 1 |
| | 2 | 80 | 20 | | | | | | | | 1 |
| | 3 | 20 | | 80 | | | | | | | 1 |
| | 4 | 30 | | 70 | | | | | | | 1 |
| | 5 | 40 | | 60 | | | | | | | 1 |
| | 6 | 50 | | 50 | | | | | | | 1 |
| | 7 | 70 | | 30 | | | | | | | 1 |
| | 8 | 80 | | 20 | | | | | | | 1 |
| | 9 | 70 | | | 30 | | | | | | 1 |
| | 10 | 80 | | | 20 | | | | | | 1 |
| | 11 | 20 | | | | 80 | | | | | 1 |
| | 12 | 30 | | | | 70 | | | | | 1 |
| | 13 | 40 | | | | 60 | | | | | 1 |
| | 14 | 50 | | | | 50 | | | | | 1 |
| | 15 | 70 | | | | 30 | | | | | 1 |
| | 16 | 80 | | | | 20 | | | | | 1 |
| | 17 | 80 | | | | 10 | | 10 | | | 1 |
| | 18 | 70 | | | | | 30 | | | | 1 |
| | 19 | 80 | | | | | 20 | | | | 1 |

| | | | | | | | | | |
|---|---|---|---|---|---|---|---|---|---|
| Comp. | 1 | | 50 | | | | 50 | | 5 |
| Ex. | | | | | | | | | |
| | 2 | | | 20 | | | 80 | | 5 |
| | 3 | 20 | | | | 80 | | | 1 |
| | 4 | | | | 50 | | | 50 | 5 |
| | 5 | 100 | | | | | | | 5 |

In the Table 1, abbreviated expressions have following meanings.

BAPS: bis(4-acryloyloxyphenyl) sulfide, a compound having hydrogen atoms as R₁-R₆ in the above-described general formula (1)

p-CPA: p-cumylphenyl acrylate, a compound having a hydrogen as R₉, a p-cumyl group as R₁₁, and n=0 in the above-described general formula (2)

o-PPA: o-phenylphenyl acrylate, a compound having a hydrogen as R₉, a o-phenyl group as R₁₁, and n=0 in the above-described general formula (2)

M-110: ethylene oxide 1 mol-modified acrylate of p-cumylphenol, Aronix M-110 manufactured by TOAGOSEI CO., LTD., a compound having hydrogen atoms as R₉ and R₁₀, a p-cumyl group as R₁₁, and n=1 in the above-described general formula (2)

TO-1463: ethylene oxide 1 mol-modified acrylate of o-phenylphenol, TO-1463 manufactured by TOAGOSEI CO., LTD., a compound having hydrogen atoms as R₉ and R₁₀, a o-phenyl group as R₁₁, and n=1 in the above-described general formula (2)

POA: phenoxyethyl acrylate, a compound having hydrogen atoms as R₉-R₁₁, and n=1 in the above-described general formula (2)

M-400: a mixture of dipentaerythritol penta- and hexa-acrylates, Aronix M-400 manufactured by TOAGOSEI CO., LTD.

M-211B: ethylene oxide 4 mole-modified diacrylate of bisphenol A, Aronix M-211B manufactured by TOAGOSEI CO., LTD.

BAEPS: bis(4-acryloyloxyethoxyphenyl) sulfide

Irg184: 1-hydroxycyclohexylphenyl ketone, IRGACURE 184, manufactured by Ciba Specialty Chemicals K.K.

TABLE 2

| | Evaluation result | | |
|---|---|---|---|
| | | Refractive | Transmittance |
| | Appearance | index | (%) |
| Example 1 | Excellent | 1.6168 | 96 |
| 2 | Excellent | 1.6212 | 96 |
| 3 | Excellent | 1.6174 | 97 |
| 4 | Excellent | 1.6217 | 97 |
| 5 | Excellent | 1.6236 | 98 |
| 6 | Excellent | 1.6225 | 96 |
| 7 | Excellent | 1.6263 | 97 |
| 8 | Excellent | 1.6258 | 96 |
| 9 | Excellent | 1.6154 | 98 |
| 10 | Excellent | 1.6198 | 98 |
| 11 | Excellent | 1.6069 | 98 |
| 12 | Excellent | 1.6148 | 98 |
| 13 | Excellent | 1.6165 | 98 |
| 14 | Excellent | 1.6224 | 98 |
| 15 | Excellent | 1.6242 | 98 |
| 16 | Excellent | 1.6252 | 98 |
| 17 | Excellent | 1.6162 | 96 |
| 18 | Excellent | 1.6100 | 97 |
| 19 | Excellent | 1.6162 | 96 |
| Comparative | Excellent | 1.5750 | 97 |
| Example 1 | | | |
| 2 | Excellent | 1.5720 | 96 |
| 3 | Excellent | 1.5660 | 96 |
| 4 | Excellent | 1.5831 | 95 |
| 5 | Poor | 1.6283 | 68 |

As is clear from Table 2, the cured article of the composition of the present invention has no turbidity, an excellent transparency and a good appearance, such high refractive index as 1.61 or more, and also a good light transmittance.

On the other hand, when compositions which contained the component (B) but did not contain the component (A) (Comparative Examples 1 and 2), a composition which contained the component (A) alone but did not contained the component (B) (Comparative Example 3), or a composition contained the component (B) and a diacrylate containing an alkylene oxide unit different from that of the component (A) (Comparative Example 4) was used, a cured article having a high refractive index could not be obtained. Further, a composition contained the component (A) alone but did not contained the component (B) and other ethylenic unsaturated group-containing compound (Comparative Example 5) gave a cured article having a high refractive index, but turbidity and insufficient light transmittance.

### APPLICATION EXAMPLE

### Production of Lens Sheet

Each of compositions obtained in Examples and Comparative Examples was used and poured to a mold having a lens shape, on which a methacrylic resin film (Sunduren, manufactured by KANEKA CORP.) as a transparent substrate was arranged.

The composition was irradiated with the ultraviolet ray through the transparent substrate under the same condition as described above to cure.

When the cured article was taken off the mold, compositions in Examples 1-19, and Comparative Examples 1, 2 and 4 were easily taken off, thereby giving lens sheets having an intended shape. Furthermore, for the compounds in Examples 1-19, they were lens sheets excellent in optical properties and the like as described above.

On the other hand, as to the composition in Comparative Example 3, the cured article damaged during taking off the mold not to give a good lens shape. As to the composition in Comparative Example 5, crystallization occurred on the casting mold before the irradiation of ultraviolet ray not to give a good lens shape.

### INDUSTRIAL APPLICABILITY

The composition of the present invention can suitably be used, as an active energy beam-curable composition for an optical material, for optical elements that require a high refractive index and high light transmittance as represented by a lens sheet such as a Fresnel lens, a lenticular lens, a prism sheet and the like used for a video projector, a projection television, a liquid crystal display and the like, and a plastic lens.

1-6. (canceled)

7. An optical material cured by exposing an actinic-energy-ray-curable composition for an optical material to an actinic-energy ray, the composition comprising (A) a di(meth)acrylate represented by the following general formula (1) and (B) a mono(meth)acrylate represented by the following general formula (2): 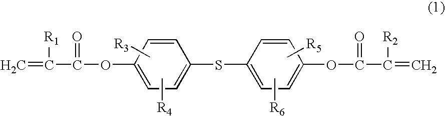
wherein R₁ and R₂ independently represent a hydrogen atom or a methyl group, R₃ and R₅ independently represent a hydrogen atom, a methyl group or an ethyl group, R₄ and R₆ independently represent a hydrogen atom, a methyl group or a bromine atom; 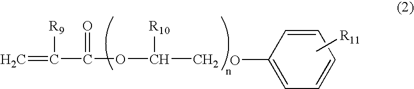
wherein R₉ and R₁₀ independently represent a hydrogen atom or a methyl group, R₁₁ represents a hydrogen atom, a phenyl group or a cumyl group, and n represents 0 or an integer of 1-5.

8. The optical material according to claim 7, wherein the composition contains 10 to 90 wt % of the component (A) and 90 to 10 wt % of the component (B).

9. The optical material according to claim 7, wherein each of R₁ and R₂ is a hydrogen atom in the general formula (1).

10. The active energy beam-curable composition for an optical material according to claim 7, wherein n is 0 and R₁₁ is a phenyl group or a cumyl group in the general formula (2).

11. The optical material according to of claim 7, wherein the composition further comprises (C) a photoinitiator.

12. The optical material according to claim 7, wherein all of R₃ to R₆ are hydrogen atoms; R₃ and R₅ are hydrogen atoms and R₄ and R₆ are methyl groups; or R₃ and R₅ are hydrogen atoms and R₄ and R₆ are bromine atoms in the general formula (1).

13. The optical material according to claim 7, wherein R₉ is a hydrogen atom in the general formula (2).

14. The optical material according to claim 7, wherein the component (A) is at least a compound selected from the group consisting of bis(4-(meth)acryloyloxyphenyl) sulfide, bis(4-(meth)acryloyloxy-3-methylphenyl) sulfide, and bis(4-(meth)acryloyloxy-3-bromophenyl) sulfide.

15. The optical material according to claim 7, wherein the component (A) is at least a compound selected from the group consisting of phenyl (meth)acrylate, p-cumylphenyl (meth)acrylate, o-phenylphenyl (meth)acrylate, m-phenylphenyl (meth)acrylate, p-phenylphenyl (meth)acrylate, phenoxyethyl (meth)acrylate, p-cumylphenoxyethyl (meth)acrylate, o-phenylphenoxyethyl (meth)acrylate, m-phenylphenoxyethyl (meth)acrylate, and p-phenylphenoxyethyl (meth)acrylate.

16. The optical material according to claim 7, wherein the optical material has a refractive index (25° C.) of 1.61 or more.

17. The optical material according to claim 7, wherein the optical material is a lens sheet or a plastic lens.

18. A method for producing an optical material comprising:
a step of applying or pouring an actinic-energy-ray-curable composition for an optical material to a casting mold having a predetermined shape, wherein the composition comprises (A) a di(meth)acrylate represented by the following general formula (1) and (B) a mono(meth)acrylate represented by the following general formula (2), and
a step of irradiating an active energy beam to the composition; 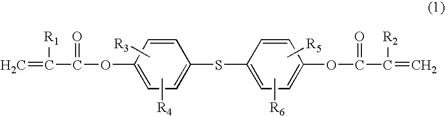
wherein R₁ and R₂ independently represent a hydrogen atom or a methyl group, R₃ and R₅ independently represent a hydrogen atom, a methyl group or an ethyl group, R₄ and R₆ independently represent a hydrogen atom, a methyl group or a bromine atom; 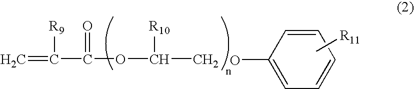
wherein R₉ and R₁₀ independently represent a hydrogen atom or a methyl group, R₁₁ represents a hydrogen atom, a phenyl group or a cumyl group, and n represents 0 or an integer of 1-5.

19. A method for producing an optical material according to claim 18, wherein the composition contains 10 to 90 wt % of the component (A) and 90 to 10 wt % of the component (B).

20. A method for producing an optical material according to claim 18, wherein each of R₁ and R₂ is a hydrogen atom in the general formula (1).

21. A method for producing an optical material according to claim 18, wherein n is 0 and R₁₁ is a phenyl group or a cumyl group in the general formula (2).

22. A method for producing an optical material according to claim 18, wherein the composition further comprises (C) a photoinitiator.

23. A method for producing an optical material according to claim 18, wherein all of R₃ to R₆ are hydrogen atoms; R₃ and R₅ are hydrogen atoms and R₄ and R₆ are methyl groups; or R₃ and R₅ are hydrogen atoms and R₄ and R₆ are bromine atoms in the general formula (1).

24. A method for producing an optical material according to claim 18, wherein R₉ is a hydrogen atom in the general formula (2).

25. A method for producing an optical material according to claim 18, wherein the component (A) is at least a compound selected from the group consisting of bis(4-(meth)acryloyloxyphenyl) sulfide, bis(4-(meth)acryloyloxy-3-methylphenyl) sulfide, and bis(4-(meth)acryloyloxy-3-bromophenyl) sulfide.

26. A method for producing an optical material according to claim 18, wherein the component (A) is at least a compound selected from the group consisting of phenyl (meth)acrylate, p-cumylphenyl (meth)acrylate, o-phenylphenyl (meth)acrylate, m-phenylphenyl (meth)acrylate, p-phenylphenyl (meth)acrylate, phenoxyethyl (meth)acrylate, p-cumylphenoxyethyl (meth)acrylate, o-phenylphenoxyethyl (meth)acrylate, m-phenylphenoxyethyl (meth)acrylate, and p-phenylphenoxyethyl (meth)acrylate.
